(19) United States
(12) Patent Application Publication
(10) Pub. No.: US 2014/0168424 A1
(43) Pub. Date: Jun. 19, 2014

(54) IMAGING DEVICE FOR MOTION DETECTION OF OBJECTS IN A SCENE, AND METHOD FOR MOTION DETECTION OF OBJECTS IN A SCENE

(71) Applicants: Ziv Attar, Zihron Yaakov (IL); Yelena Vladimirovna Shulepova, Eindhoven (NL); Edwin Maria Wolterink, Valkenswaard (NL); Koen Gerard Demeyer, Genk (BE)

(72) Inventors: Ziv Attar, Zihron Yaakov (IL); Yelena Vladimirovna Shulepova, Eindhoven (NL); Edwin Maria Wolterink, Valkenswaard (NL); Koen Gerard Demeyer, Genk (BE)

(21) Appl. No.: 14/234,083

(22) PCT Filed: Jul. 20, 2012
(86) PCT No.: PCT/NL2012/050522

§ 371 Date: Feb. 26, 2014

Related U.S. Application Data
(60) Provisional application No. 61/510,148, filed on Jul. 21, 2011.

(51) Int. Cl. H04N 7/18

(52) U.S. Cl. CPC H04N 7/18
USPC 348/140

(57) ABSTRACT

The present invention relates to an imaging device for motion detection of objects in a scene, and method for motion detection of objects in a scene. Generally the present invention relates to a system and method for creating a three dimensional image or image sequence (hereinafter “video”), and more particularly to a system and method for measuring the distance and actual 3D velocity and acceleration of objects in a scene.

The present invention relates to an imaging device for motion detection of objects in a scene, and method for motion detection of objects in a scene. Generally the present invention relates to a system and method for creating a three dimensional image or image sequence (hereinafter “video”), and more particularly to a system and method for measuring the distance and actual 3D velocity and acceleration of objects in a scene.

A standard camera consisting of one optical lens and one detector is normally used to photograph a scene. The light emitted or reflected from objects in a scene is collected by the optical lens and focused on to a photosensitive detector, usually a solid stage imaging element such as CMOS or CCD. This method of imaging does not provide any information related to distances between the object in the scene and the camera. For some applications it is essential to detect the distance and the application specific features of interest for objects in a scene. Typical application s are gesture recognition, automobile security, computer gaming and more.

US 20100/208038 relates to a system for recognizing gestures, comprising a camera for acquiring multiple frames of image depth data an image acquisition module configured to receive the multiple frames of image depth data from the camera and process the image depth data to determine feature positions of a subject; a gesture training module configured to receive the feature positions of the subject from the image acquisition module and associate the feature positions with a pre-determined gesture; a binary gesture recognition module configured to receive the feature positions of the subject from the image acquisition module and determine whether the feature positions match a particular gesture; a real-time gesture recognition module configured to receive the feature positions of the subject from the image acquisition module and determine whether the particular gesture is being performed over more than one frame of image depth data.

US 2008/0240508 relates to a motion detection imaging device comprising: plural optical lenses for collecting light from an object so as to form plural single-eye images seen from different viewpoints; a solid-state imaging element for capturing the plural single-eye images formed through the plural optical lenses; a rolling shutter for reading out the plural single-eye images from the solid-state imaging element along a read-out direction; and a motion detection means for detecting movement of the object by comparing the plural single-eye images read out from the solid-state imaging element by the rolling shutter.

US 2009/0153710 relates to an imaging device, comprising: a pixel array having a plurality of rows and columns of pixels, each pixel including a photo sensor; and a rolling shutter circuit operationally coupled to the pixel array, said shutter circuit being configured to capture a first image by sequentially reading out selected rows of integrated pixels in a first direction along the pixel array and a second image by sequentially reading out selected rows of integrated pixels in a second direction along the pixel array different from the first direction.

WO 2008/087652 relates to method for mapping an object, comprising: illuminating the object with at least two beams of radiation having different beam characteristics; capturing at least one image of the object under illumination with each of the at least two beams; processing the at least one image to detect local differences in an intensity of the illumination cast on the object by the at least two beams; and analysing the local differences in order to generate a three-dimensional (3D) map of the object.

U.S. Pat. No. 7,268,858 relates to the field of distance measuring solid state imaging element s and methods for time-of-flight (TOF) measurements.

WO 2012/040463 relates to active illumination imaging systems that transmit light to illuminate a scene and image the scene with light that is reflected from the transmitted light by features in the scene.

US20060034485 relates to a multimodal point location system comprising: a data acquisition and reduction processor disposed in a computing device; at least two cameras of which at least one of said cameras is not an optical camera, at least one of said cameras being of a different modality than another, and said cameras providing image data to said computing device; and a point reconstruction processor configured to process image data received through said computing device from said cameras to locate a point in a three-dimensional view of a target object

In many applications it is essential to detect the actual 3D velocity of objects in a scene. Object velocity is usually calculated by using more than one frame and measuring the change in position of objects between consecutive frames. The measured change in position of the objects between consecutive frames, measured in pixels, is divided by the time difference between the consecutive frames, measured in seconds, equals to the velocities of the objects. Hence, the velocities of the objects are measured in pixels per seconds and it refers to the velocity of an object in an image of a scene as appears on the solid state imaging element. This velocity will be referred to hereinafter as “image velocity”.

An object of the present invention is to provide a device for motion detection of objects in a scene, i.e. in 3D, wherein the angular velocity is converted in the actual 3D velocity of the object and their features of interest.

The present inventors found that this object can be achieved by an imaging device for motion detection of objects in a scene comprising:

plural optical lenses for collecting light from an object so as to form plural single-eye images seen from different viewpoints;

a solid-state imaging element for capturing the plural single-eye images formed through the plural optical lenses;

a rolling shutter for reading out the plural single-eye images from the solid-state imaging element along a read-out direction; and

a motion detection means for detecting movement of the object by comparing the plural single-eye images read out from the solid-state imaging element by the rolling shutter,

a depth detection means for detecting the 3D position of the object wherein the plural optical lenses are arranged so that the positions of the plural single-eye images formed on the solid-state imaging element by the plural optical lenses are displaced from each other by a predetermined distance in the read-out direction and wherein the angular velocity generated by the detection means are converted into a 3D-velocity by application of depth mapping selected from the group consisting of time of flight (TOF), structured light and triangulation and acoustic detection.

Preferred embodiments of the present device and method can be found in the appending claims and sub claims.

The measured velocities in pixel per seconds can be converted to angular velocity. The conversation is conducted using the focal length of the lens.

V_ANGULAR(RAD/sec)=V(pixels/sec)×PIXEL SIZE (in mm)/FOCAL LENGTH (in mm)

For determining the velocity of the object in a scene, also referred to hereinafter as “object velocity”, the object distance between the object and the camera and the angular velocity are required.

V(meters/sec)=V_ANGULAR×OBJECT DISTANCE (in meters)

Measuring the image and object velocity using multiple frames is very limited due to the time difference between consecutive frames which is relatively long. The time difference depends on the frame rate of a standard camera, which is typically 30-200 frames per seconds. Measuring high velocities and fast changing velocities requires much shorter time between frames which will lead to insufficient exposure time in standard cameras. The reading time difference can be shortened by improving the frame rate. However, there is a limit to improving the frame rate because of a restriction not only on output speed with which the solid-state imaging element outputs (is read out) image information from the pixels but also on processing speed of the image information. Accordingly, there is a limit to shortening the reading time difference by increasing the frame rate.

An array based camera consisting of two or more optical lenses for imaging in both lenses a similar scene or at least similar portions of a scene can measure the fast changes in a scene (i.e. moving object). The camera further consists of an image solid state imaging element that is exposed in a rolling-shutter method also so know as ERS ‘electronic rolling shutter’.

Any combination of a lens with a solid state imaging element can function a camera and produces a “single eye image”. The solid state imaging element may be shared by at least two lenses. In this way a multiple lens camera can function as being a set of separate multiple camera's.

The present invention applies 3D depth maps or a data set with 3D coordinates, based on measuring depth position of features of interest of an object in a scene, chosen from the group of time of flight (TOF), structured light and triangulation based systems and acoustic detection.

In an embodiment of the present invention depth mapping is carried out by triangulation. The triangulation based system either uses natural illumination from the scene or an additional illumination source projecting structured light pattern on the object to be mapped.

According to an embodiment of the present invention 3D image acquisition is carried out on the basis of stereo vision (SV). The advantage of stereo vision is that it achieves high resolution and simultaneous acquisition of the entire range image without energy emission or moving parts.

According to another embodiment of the present invention other range measuring devices such as laser scanners, acoustic or radar sensors are used.

A triangulation based depth sensing stereo system according to an embodiment of the present invention consists of two (or more) cameras located at different positions. When using two cameras, both capture light reflected or emitted or both from the scene, however since they are positioned differently with respect to objects in the scene, the captured image of the scene will be different in each camera.

A physical point is taken up in the observed 3D-scene by two cameras. If the corresponding pixel of this point is found in both camera images, the position can be computed with the help of the triangulation principle. Assuming that both images are synthetically placed one over the other in such that all objects at one specific distance (hereinafter D1) perfectly overlap each other, the objects that are not at that same distance D1 will then not overlap. Measuring the misalignment of certain objects that are not at distance D1 can be done using edge detection algorithm or any other algorithm auto correlation or disparity algorithm. The amount of misalignment will be calculated in units of pixels or millimetres on the image plane (the detector plane), converting this distance in to actual distance requires prior knowledge of the distance between the two cameras (hereinafter CS—Camera separation) and the focal length of the cameras lenses.

Formula for calculation the distance of an object using:
CS—Camera separation in mm
D1—Reference distance mm
FL—focal length of the cameras lenses
δx—Miss alignment of an object at distance D2 in mm
D2=function of: δx,CS,D1,FL
When D1 is set to Infinity

D2=CS*FL/δx
CS and FL are constants therefore D2 is linear with 1/δx]

The working distance of a triangulation based system can be increased through combining at least two different sets of apertures with a different distance between the two apertures in the set:

If only two cameras are used, it is preferable to separate the cameras apart so that the required depth resolution can be assured at the maximal working distance (3 meters for example). By introducing a relatively high separation between the cameras, the capability to detect depth is limited for objects very close to the cameras.

When objects are very close they appear at very different relative locations on the 2 images of the 2 cameras thus tadding complexity to the shift detection algorithms causing them to be less efficient in terms of computation time and accuracy of the depth calculation.

When objects are positioned very close to the cameras the fields of view of the two cameras do not fully overlap and at a certain distance may not overlap at all making it impossible to obtain depth information.

When each one of the two or more cameras are multi aperture cameras able to provide depth information as a standalone camera, it is then possible to achieve a wider working range by using the depth information acquired by each one of the multi aperture cameras or by using information from both when objects are far away from the cameras. The advantage of using this method and adaptively choosing the cameras to be used for depth calculation is that the present inventors are able to increase the operating range.

Now the operation method will be discussed briefly. For each frame in a video sequence the distance will be calculated using an algorithm applied on the images acquired by each one of the multi aperture cameras separately. If the distance is high it will not be accurate enough and will suffer from a large depth error. If the distance is considered high which means that it is above a certain predefined value, the algorithm will automatically recalculate the distance using images captured by both multi aperture cameras. Using such a method will increase the range in which the system is operational without having to compromise the depth accuracy at long distances.

A triangulation based depth sensing stereo system according to another embodiment of the present invention consists of two (or more) cameras located at different positions and an additional illumination source. When illuminating an object with a light source; the object can be more easily discerned from the background. The light is usually provided in pattern (spots, lines etc). Typical light sources are solid state based such as LED's, VCSELS or laser diodes. The light may be provided in continuous mode or can be modulated. In the case of scanning systems such as LIDAR; the scene is scanned pixel by pixel through added a scanning system on the illumination source.

In an embodiment according to the present invention depth mapping is carried out on basis of time of flight. Time of Flight (ToF) cameras provide a real-time 2.5-D representation of an object. A Time of Flight depth or 3D mapping device is an active range system and requires at least one illumination source. The range information is measured by emitting a modulated near-infrared light signal and computing the phase of the received reflected light signal. The ToF solid state imaging element captures the reflected light and evaluates the distance information on the pixel. This is done by correlating the emitted signal with the received signal. The distance of the solid state imaging element to the illuminated object/scene is then calculated for each solid state imaging element pixel. The object is actively illuminated with an incoherent light signal. This signal is intensity modulated by a signal of frequency. Traveling with the constant speed of light in the surrounding medium, the light signal is reflected by the surface of the object. The reflected light is projected trough the camera lens back on the solid state imaging element.

By estimating the phase-shift f (in rad) between both, the emitted and reflected light signal, the distance d can be computed as follows:

$$d = \frac{c}{2 f} \cdot \frac{φ}{2 π}$$

### Where:

c [m/s] denotes the speed of light,
d [m] the distance the light travels,
f [MHz] the modulation frequency,
−φ [rad] the phase shift

Based on the periodicity of e.g. a cosine-shaped modulation signal, this equation is only valid for distances smaller than c/2 f. In the case that ToF cameras operate at a modulation frequency of e.g. 20 MHz. this upper limit for observable distances of these ToF camera systems is approximately 7.5 m.

3D acoustic images are formed by active acoustic imaging devices. An acoustic signal is transmitted and the returns from target of the object are collected and processed in such a way that acoustical intensities and range information can be retrieved for several viewing directions An acoustic depth mapping device consists of a microphone array with implemented camera, and a data recorder for calculating the acoustic and software sound map. Acoustic and optical image may be combined with specific software.

Several of above mentioned 3D mapping devices may be combined in a multimodal mode in order to increase complementarily, redundancy and reliability of the system as discussed in US 20060034485.

Most of above mentioned image capturing elements, depth or distance capturing elements; illumination sources and MEMS acoustic elements are based on solid state technology using a semiconductor material as substrate Any combination of these elements may therefore share the same substrate such as silicon.

### EMBODIMENT 1: MEASURING THE OBJECT VELOCITY

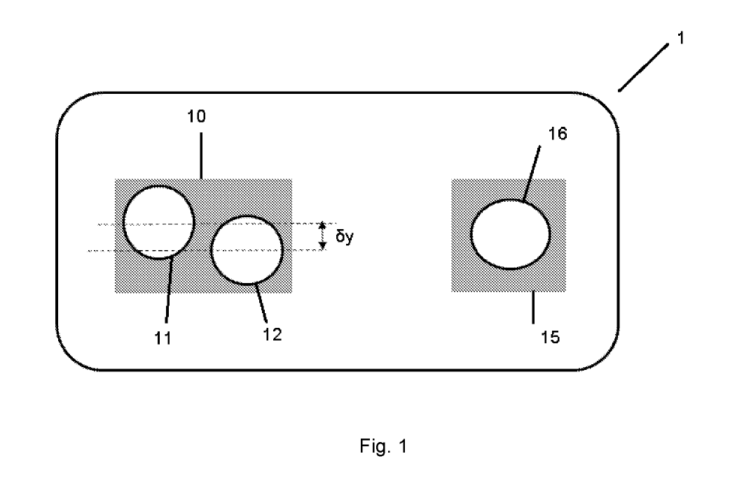

In this preferred embodiment (FIG. 1), the imaging device for motion detection 1 comprises two cameras, one two lens camera includes at least 2 lenses 11,12 and a solid state imaging element 10 and the other camera has one lens 16 on another solid state imaging element 15. The lenses 11,12 are preferably identical in size and have similar optical design. The lenses 11,12 aligned horizontally as illustrated in FIG. 1 and are positioned so that the centre of the lenses have a different Y-coordinate and such that the difference in the Y-coordinate is defined (“y-shift indicated by δy in FIG. 1). The second camera with single lens 15 is used a the second camera for the triangulation measurement.

This embodiment enables extended working distances because two sets of triangulation measurements are available: i.e. between lenses 11,12 and between anyone of them and lens 16.

When imaging an object, light is emitted or reflected from the object and is focused by each lens 11,12 onto a different area on the solid state imaging element. Due to the shifting between the lenses 11,12 in the dual eye camera, all imaged objects in the two images of each camera will have the same shifting. More specifically, a difference in the Y-coordinate in the horizontally aligned lenses will form two images having the same difference in the Y-coordinate.

When the solid state imaging elements work in a rolling shutter method of acquisition, each row of pixels starts and ends the exposure at a different time. In general, rolling shutter (also known as line scan) is a method of image acquisition in which each frame is recorded not from a snapshot of a single point in time, but rather by scanning across the frame either vertically or horizontally. In other words, not all parts of the image are recorded at exactly the same time, even though the whole frame is displayed at the same time during playback. This in contrast with global shutter in which the entire frame is exposed for the same time window. This produces predictable distortions of fast-moving objects or when the solid state imaging element captures rapid flashes of light. This method is implemented by rolling (moving) the shutter across the exposable image area instead of exposing the image area all at the same time (the shutter could be either mechanical or electronic). The advantage of this method is that the image solid state imaging element can continue to gather photons during the acquisition process, thus increasing sensitivity.

As mentioned above, due to the shift between the lenses a similar shift exists between the images. Thus, when comparing the images of each camera separately, a change in the positioning of the object can be calculated. When using a solid state imaging element with a rolling shutter that rolls across rows on the solid state imaging element and placing two imaging lenses with a small shift between the lens so that the centre of each lens is aligned with a different row of the solid state imaging element, the resulting images will be similar but shifted by a few rows.

When a static scene is imaged one will only notice a change in the position of the image on the solid state imaging element but because of the rolling shutter the two images are not exposed at same time and the time difference between the images is proportional to the shift between the lenses.

Due to the time difference of the exposure of the two images it is possible to calculate the change in position of objects in a very short time. The rolling shutter starts it exposure at each line at a different time. This time difference is equal to the total exposure time divided by the number of rows on the solid state imaging element.

For example a solid state imaging element having 1000 rows when exposed at 20 milliseconds will demonstrate a time difference of 20 microseconds between each row. Using a shift of 100 rows between the lenses will result in two images on the solid state imaging element that are shifted by 100 pixels but also have a difference in the exposure start time of 200 microseconds.

Using an algorithm to detect the differences in the scene between the images allows us to detect fast moving objects and measure their velocity.

Calculating the actual object velocity in meters per second units

The velocity is measured by pixels per second to determine the actual velocity in m/sec, the distance between the camera and the object must be known.

The actual 3D velocity equation:

Vm/sec=(Vpixel/sec)×(Object distance)/(Focal length)

Now the image date processing is discussed.

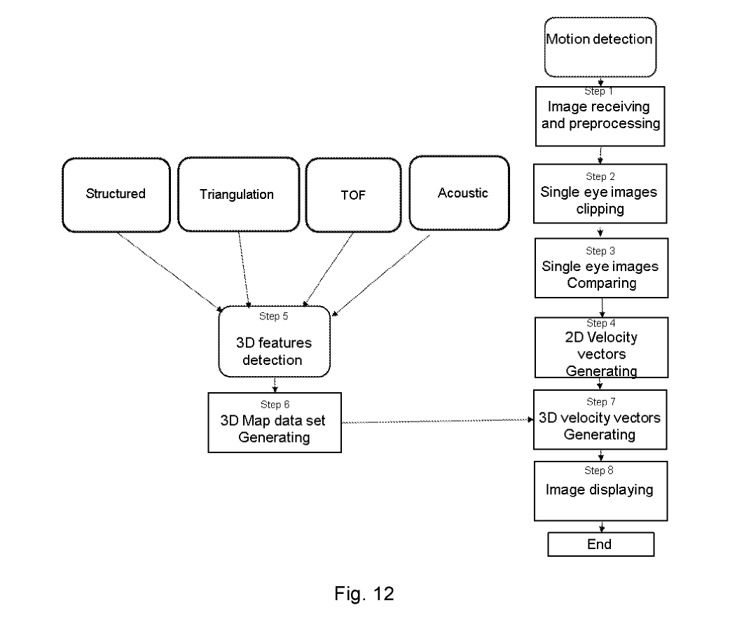

The flow chart in FIG. 12 process is described performed by the motion detection imaging device 1 according to the present embodiment.

(Step 1).

The microprocessor 903 receives from the image processor 916 the image information which the image processor 16 reads from the compound-eye imaging device 1 and performs various corrections.

(Step 2)

Subsequently, the microprocessor 903 clips the single-eye images obtained trough optical lenses 11 and 12 from the above-described image information.

(Step 3)

Subsequently, the microprocessor 903 compares the single-eye images obtained trough optical lenses 11 and 12, 11 and 12 on a unit pixel G basis.

(Step 4).

Velocity vectors are generated on a unit pixel basis from the position displacements between corresponding unit pixels on the single-eye images obtained from optical lenses 11, 12 and

(Step 5)

The microprocessor 903 receives 3D feature coordinates from the 3D mapping device being here the triangulation result between the any lens pair of the motion detection device 1. The image information is read by the image processor 916 from the compound-eye imaging device from the solid state imaging elements 10 and 15.

(Step 6)

Microprocessor 903 generates 3D map from data obtained by Step 4

(Step 7)

Microprocessor 903 fuses 3D coordinate sets with velocity data obtained in step 4.

(Step 8)

The 3D velocity vectors are further processed to the display unit.

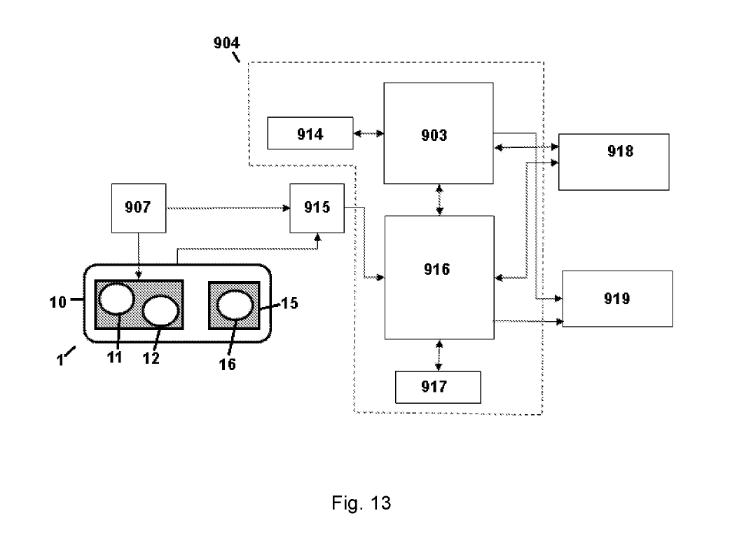

The processing steps can be executed on a hardware platform as shown in FIG. 13. An electronic circuit 904 comprises a microprocessor 903 for controlling the entire operation of the motion detection imaging device and for the depth detection means for detecting the 3D position of the object. The motion detection and depth detection processing steps can be integrated in one chip or may be processed on two separate chips.

Further, at least one memory stores 914 various kinds of setting data used by the microprocessor 903 and stores the comparison result between the single-eye images acquired through lens 11 and the single-eye acquired through lens 12.

An image processor 916 reads the image information from the compound-eye imaging device with lenses 11, 12 and the other camera has one lens 16 on another solid state imaging element 15. This occurs through an Analogue-to-Digital converter 915 that performs the usual image processing such as gamma correction and white balance correction of the image information by converting the image information into a form that can be processed by microprocessor 903. The image processing and A/D converting process may also be performed on separate devices. Another memory 917 stores various kinds of data tables used by the image processor and it also stores temporarily image data while processing. The microprocessor 903 and the image processor 916 are connected to external devices such as a personal computer 918 or a display unit 919.

### EMBODIMENT 2: TWO LENSES ON ONE SHARED SOLID STATE ELEMENT

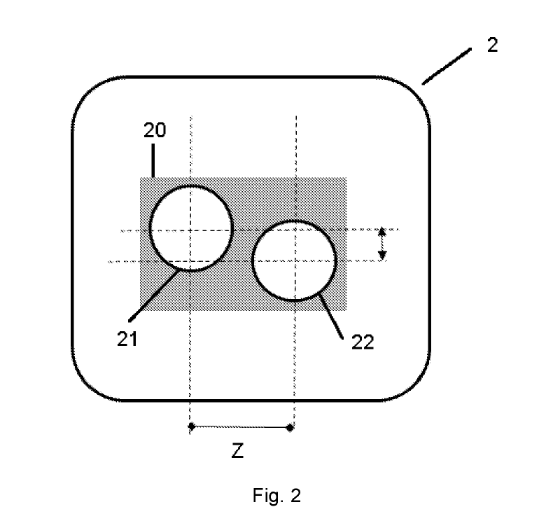

In this embodiment (FIG. 2), the imaging device for motion detection 2 has a camera including at least two lenses 21, 22 and a solid state imaging element 20. The lenses 21, 22 are preferably identical in size and have similar optical design. The lenses 21, 22 aligned horizontally as illustrated in FIG. 2 and are positioned so that the centre of the lenses have a different Y-coordinate and such that the difference in the Y-coordinate is defined (“y-shift indicated by δy in FIG. 2”). As the two lenses are displaced with a separation marked with “z”, they can be treated as two lens openings of a triangulation system. Similar triangulation algorithm can be used to provide 3D coordinated of the features of interest. This set up is very compact but the working range is more limited compared to embodiment 1, because there is only one close pair of lenses 21, 22 present.

### EMBODIMENT 3: TWO ORTHOGONAL CAMERA'S

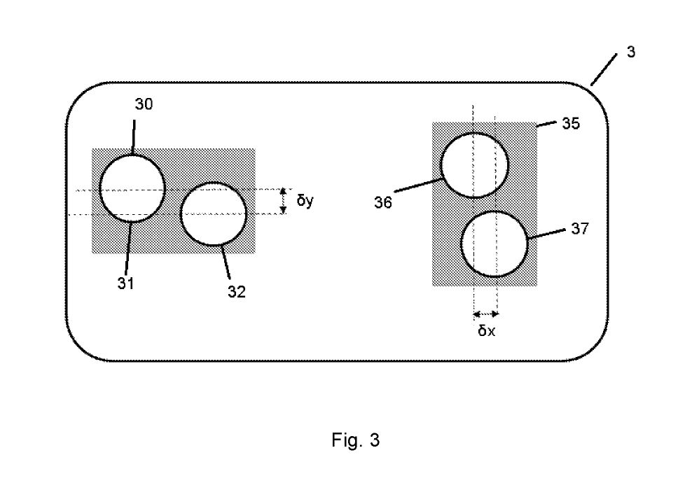

In this preferred embodiment (FIG. 3), the imaging device for motion detection 3 comprises two orthogonal sets of lenses 31, 32 and 33, 34 with respective solid state imaging elements 30 and 35. The lenses are preferably identical in size and have similar optical design. A first camera includes a set of lenses 31, 32 aligned horizontally as illustrated in FIG. 3 and are positioned so that the centre of the lenses have a different Y-coordinate and such that the difference in the Y-coordinate is defined (“y-shift”). A second camera includes a set of lenses 36, 37 aligned vertically as illustrated in FIG. 3 and are positioned so that the centre of the lenses have a different X- and such that the difference in the X-coordinate is defined.

This set up enables to apply the rolling shutter based velocity measurement in two orthogonal directions.

### EMBODIMENT 4: MEASURING THE OBJECT ACCELERATION

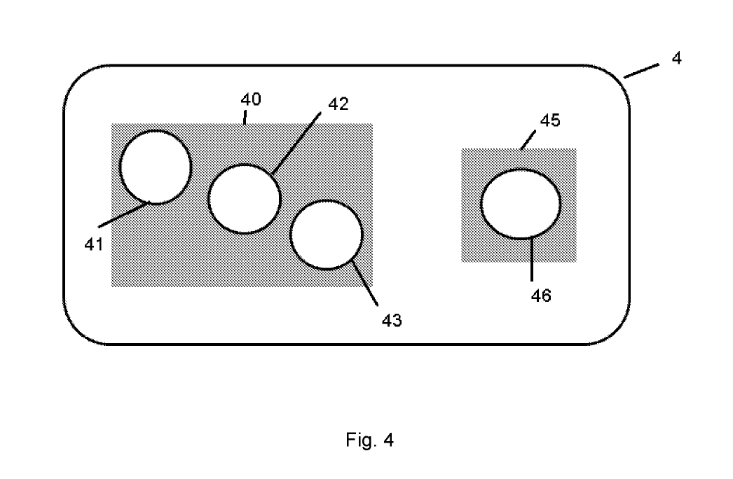

In this preferred embodiment (FIG. 4), the imaging device for motion detection 4 comprises two cameras, one camera comprises at least 3 lenses 41, 42, 43 and a solid state imaging element 40 and the other camera has one lens 46 on another solid state imaging element 45 The lenses 41, 42, 43 are preferably identical in size and have similar optical design. The lenses 41, 42, 43 aligned horizontally as illustrated in FIG. 4 and are positioned so that the centre of the lenses have a different Y-coordinate and such that the difference in the Y-coordinate is defined The second camera with single lens 45 and is used a the second camera for the triangulation measurement in a similar way as in Embodiment 1.

This embodiment enables extended working distances because two sets of triangulation measurements are available i.e. between lenses 41, 42, 43 and between anyone of them and lens 46.

To obtain information of the acceleration of an object. Force is proportional to mass and acceleration so when a mass does not change such as a mass of a human organ as a hand, the acceleration is directly proportional to sum of forces and being capable to measure force in a remote manner using imaging systems can be very useful for many application. For example for gaming systems that involve combat arts it is very useful to determine the force applied by a gamer.

Measuring acceleration can be done in a similar way as described above for obtaining velocity information. Measuring acceleration can be achieved using 3 lenses 41, 42, 43 that are aligned with the solid state imaging elements rows but with small a shift between the three lenses 41, 42, 43: Using three lenses with small shifts between them and detecting the shifts of certain objects in the scene by means of computer algorithm can allow us to calculate acceleration. The method is similar to the one described above for calculating velocity but applied to the three images formed by the three lenses 41,42,43. By capturing three images with very small time differences allows to calculate two velocities (shift between image of lens 41 and lens 42 and shift between image of lens 41 and 43 or 42 and 43). Using the velocity as calculated at using the different images formed be the different lenses allows us to determine the change in velocity in a very short time difference which is exactly the definition of acceleration.

### EMBODIMENT 5: DIFFERENT READ OUT DIRECTIONS

The rolling shutters on two different solid state imaging elements can be operated in different orientations depending on the mutual orientation of the solid state imaging elements. They can be aligned in the same direction or can be mutually rotated 90 degrees, 180 degrees or any angle in between.

As disclosed in US 2009/0153710, more than one rolling shutter can be operated on the same solid state element in different directions.

It is difficult to accurately detect shifts of objects with edges that are aligned with solid state imaging element columns therefore it is preferred to use two solid state imaging elements each having two lenses or more with a small shift of a few rows between the lenses centres.

One of the solid state imaging elements is rotated by 90 degrees so that any horizontal line in the scene will appear coincide with solid state imaging element columns. This will assure that the algorithm which needs to detect the shifts of the objects in the scene will perform well for any type of objects.

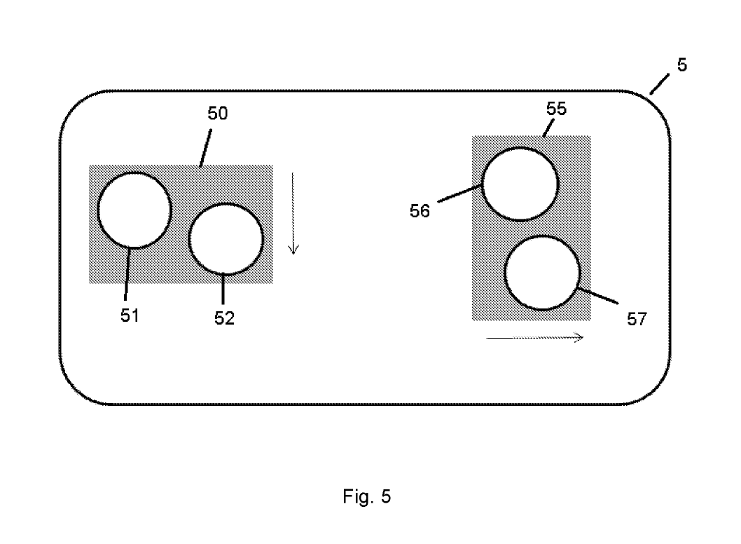

As in preferred embodiment (FIG. 5), the imaging device for motion detection 5 comprises two orthogonal sets of lenses 51, 52 and 56, 57 with respective solid state imaging elements 50 and 55. The lenses are preferably identical in size and have similar optical design. A first camera includes a set of lenses 51,52 aligned horizontally as illustrated in FIG. 5 and are positioned so that the centre of the lenses have a different Y-coordinate and such that the difference in the Y-coordinate is defined (“y-shift”). A second camera includes a set of lenses 56,57 aligned vertically as illustrated in FIG. 5 and are positioned so that the centre of the lenses have a different X- and such that the difference in the X-coordinate is.

The arrows show the read out sequence of the rolling shutter.

In a more simplified form, lens 57 is removed to obtain a similar configuration as in FIG. 1 of Embodiment 1).

### EMBODIMENT 6: COLOR FILTERS ASSIGNED TO LENSES

Solid state Image elements are usually provided with a color filters with a color assigned to pixel level in a specific pattern, such as a Bayer pattern. By assigning specific color filters on aperture level, the optical and color based tasks can be assigned on aperture level. High dynamic range are obtained by including white or broad band filters,

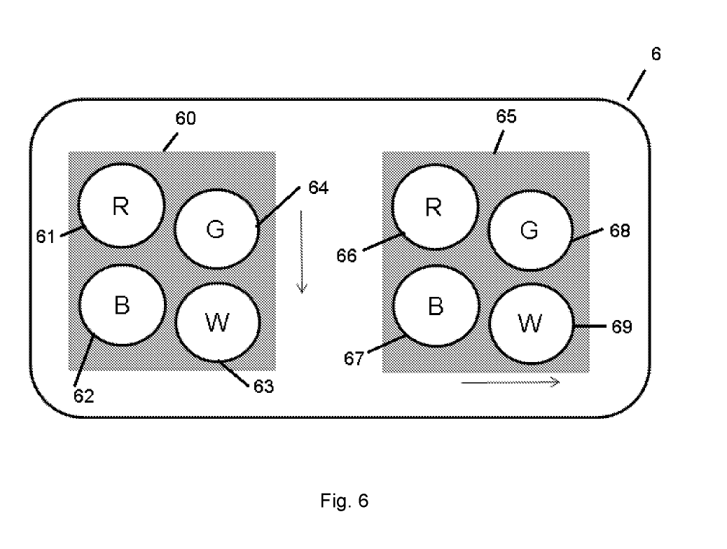

As in an preferred embodiment (FIG. 6), the imaging device for motion detection 6 comprises two of lenses 61, 62, 63, 64 and 66, 67, 68, 69 with respective solid state imaging elements 60 and 65. The lenses are preferably identical in size and have similar optical design and optionally adapted to the color filter. In this case a Red color filter is assigned to lenses 61, 65, green filters to lenses 64, 68, blue filters to lenses 62, 67 and white to lenses 63, 69.

As explained in Embodiment 5; shutter read outs may be parallel or orthogonal.

It must be clear that many combinations of color filters are possible.

One of the solid state elements 60 65 may contain fewer lenses as long at least two color filters exist two produce color pictures or color based data.

### EMBODIMENT 7: COLOR

By assigning specific color filters on aperture level, even more color based functionalities can be combined with velocity measurement. These functionalities comprise near infra red detection and multispectral, hyper spectral velocity measurement;

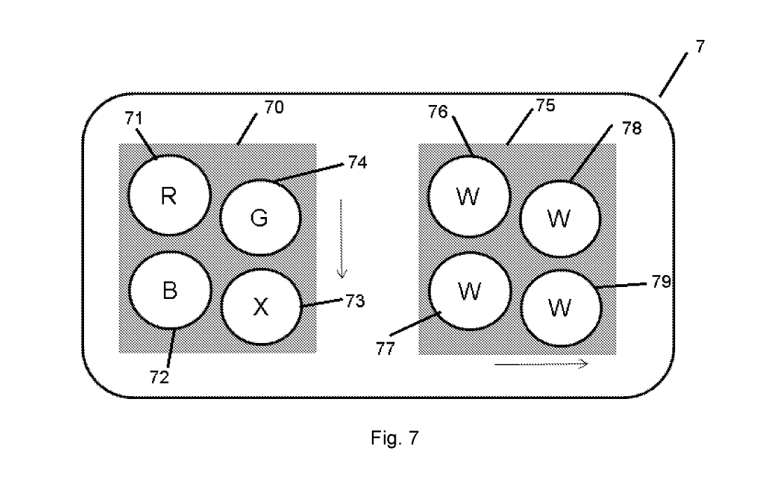

As in an preferred embodiment (FIG. 7), the imaging device for motion detection 7 comprises two of lenses 71, 72, 73, 74 and 76, 77, 78, 79 with respective solid state imaging elements 70 and 75. The lenses are preferably identical in size and have similar optical design and optionally adapted to the color filter. In this case a Red color filter is assigned to lenses 71, a green filter to lens 74, a blue filter to lens 72, a Near Infra Red filter to lens 73 and a white filter to lenses 76, 77, 78, 79.

As explained in Embodiment 5 shutter read outs may be parallel or orthogonal.

It must be clear that many combinations of color filters are possible.

One of the solid state elements 70 75 may contain fewer lenses as long at least two color filters exist two produce color pictures or color based data

### EMBODIMENT 8: STRUCTURED LIGHT

Adding visible or infrared light source such as LED's, laser diodes and VCSELS improves the image quality and reduce exposure time allowing a higher frame rate.

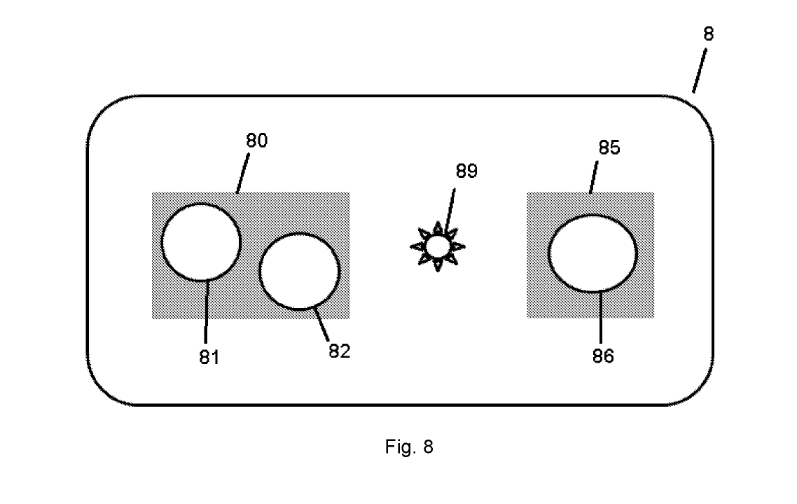

In this preferred embodiment (FIG. 8), the imaging device for motion detection 8 comprises two cameras, one two lens camera includes at least two lenses 81,82 and a solid state imaging element 80 and the other camera has one lens 86 on another solid state imaging element 85. The lenses 81,82 are preferably identical in size and have similar optical design. The lenses 81,82 aligned horizontally as illustrated in FIG. 8 and are positioned so that the centre of the lenses have a different Y-coordinate and such that the difference in the Y-coordinate is defined (“y-shift indicated by δy in FIG. 8”). The second camera with single lens 85 and is used a the second camera for the triangulation measurement.

This embodiment enables extended working distances because two sets of triangulation measurements are available: i.e. between lenses 88,82 and between anyone of them and lens 86.

### EMBODIMENT 9: TIME OF FLIGHT

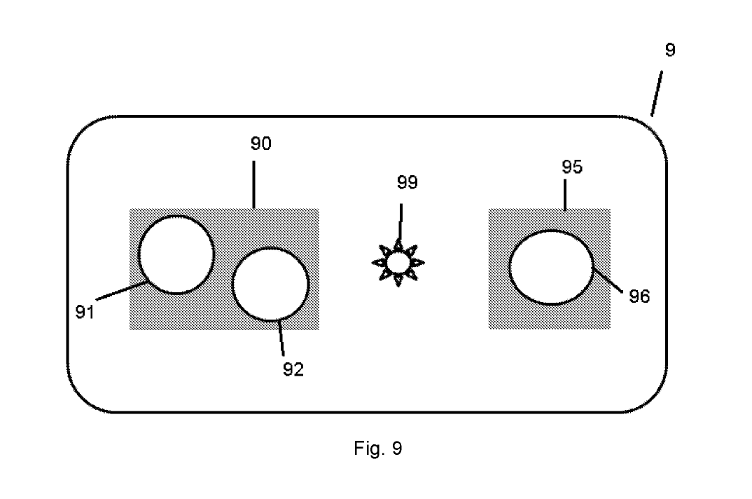

In this preferred embodiment (FIG. 9), for a time-of-flight camera a camera consists of the following elements:

Illumination unit 89: illuminates the scene. As the light has to be modulated with high speeds up to 100 MHz, only LEDs or laser diodes are feasible. The illumination normally uses infrared light to make the illumination unobtrusive. A lens 96 gathers the reflected light and images of the environment onto the solid state imaging element solid state imaging element 95. An optical band pass filter (not shown) only passes the light with the same wavelength as the illumination unit. This helps suppress background light. Image solid state imaging element 95 is the heart of the TOF camera. Each pixel measures the time the light has taken to travel from the illumination unit to the object and back. In the TOF driver electronics, both the illumination unit 99 and the image solid state imaging element 95 have to be controlled by high speed signals. These signals have to be very accurate to obtain a high resolution. For each image in a video sequence the distance will be calculated using an algorithm applied on the images acquired by the TOF camera. A Computation/Interface (not shown) calculates the distance directly in the camera. To obtain good performance, some calibration data is also used. The camera then provides a distance image over a USB or Ethernet interface.

### EMBODIMENT 10: TIME OF FLIGHT WITH ARRAY OF ILLUMINATION SOURCES

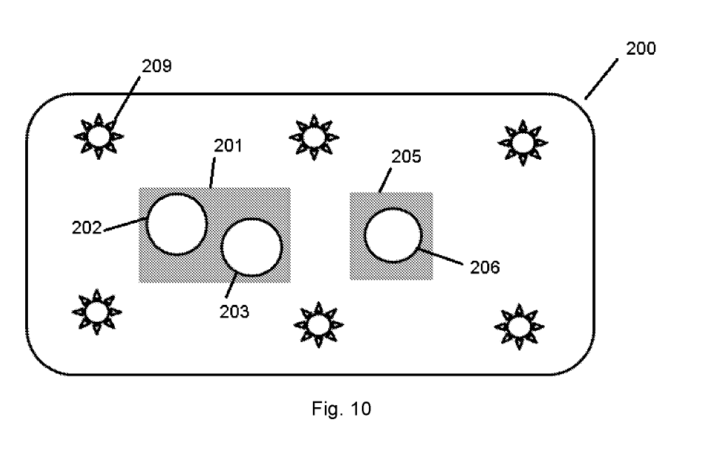

This preferred embodiment (FIG. 10), is similar to embodiment 9; the imaging device for motion detection 200 comprises multiple illumination sources 209 distributed over the device 200.

### EMBODIMENT 11: ACOUSTIC DEPTH DETECTION

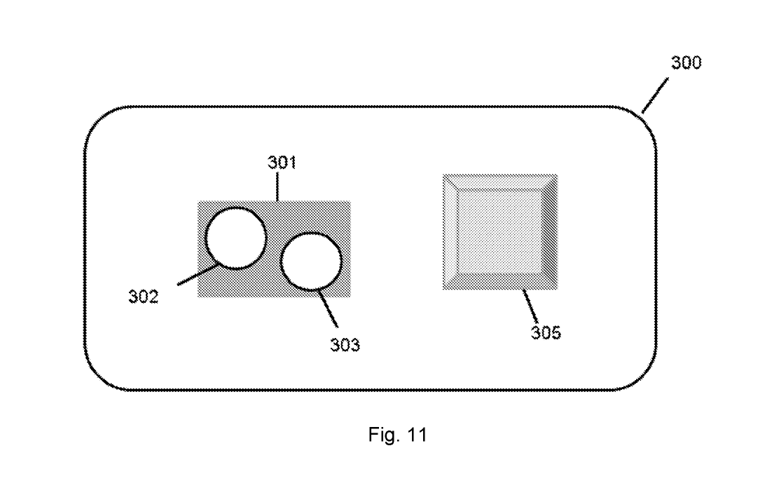

In this embodiment (FIG. 11), the imaging device for motion detection 300 comprises two cameras, one two lens camera includes at least two lenses 301,302 and a solid state imaging element 301 and a acoustic camera 305. The lenses 301,302 are preferably identical in size and have similar optical design. The lenses 301,302 aligned horizontally as illustrated in FIG. 11 and are positioned so that the centre of the lenses have a different Y-coordinate and such that the difference in the Y-coordinate is defined (“y-shift indicated by δy in FIG. 11”).

The sonar camera may comprise a single detector or array of sonar detectors.

Each of the cameras is focused upon a target object and acquire each different two-dimensional image views. The cameras are connected to a computing device (not shown) with a point 3_D reconstruction processor. This computing process may happen in a separate microprocessor or the same microprocessor 903 in FIG. 13. The point reconstruction processor can be programmed to produce a three-dimensional (3-D) reconstruction of point of the feature of interest, and finally 3-D reconstructed object by locating different matching points in the image views of the dual lens camera with lenses 302,303 and the acoustic camera 305.

This embodiment enables extended working distances because two sets of triangulation measurements are available: i.e. between lenses 301,302 and between anyone of them and the acoustic camera.

1. An imaging device for motion detection of objects in a scene comprising:
plural optical lenses for collecting light from an object so as to form plural single-eye images seen from different viewpoints;
a solid-state imaging element for capturing the plural single-eye images formed through the plural optical lenses;
a rolling shutter for reading out the plural single-eye images from the solid-state imaging element along a read-out direction; and
a motion detection means for detecting movement of the object by comparing the plural single-eye images read out from the solid-state imaging element by the rolling shutter,
a depth detection means for detecting the 3D position of the object wherein the plural optical lenses are arranged so that the positions of the plural single-eye images formed on the solid-state imaging element by the plural optical lenses are displaced from each other by a predetermined distance in the read-out direction and wherein the angular velocity generated by the detection means are converted into a 3D-velocity by application of depth mapping selected from the group consisting of time of flight (TOF), structured light, triangulation and acoustic detection.

2. An imaging device for motion detection of objects in a scene according to claim 1, wherein the respective single-eye images formed on the solid-state imaging element partially overlap each other in the read-out direction.

3. An imaging device for motion detection of objects in a scene according to claim 1, wherein at least two solid-state imaging elements are present, wherein one of said elements is rotated by 90 degrees.

4. An imaging device for motion detection of objects in a scene according to claim 1, wherein different color filters are assigned to said plural optical lenses.

5. An imaging device for motion detection of objects in a scene according to claim 1, wherein at least one light source illuminates the object.

6. An imaging device for motion detection of objects in a scene according to claim 5, wherein said light source is selected from the group of LED's, VCSELS or laser diodes.

7. An imaging device for motion detection of objects in a scene according to claim 5, wherein the light source operates in different modes of the group of continuous, time modulated and scanning mode.

8. An imaging device for motion detection of objects in a scene according to claim 1, wherein at least at least one of the solid-state imaging elements records time differences of reflected time modulated light from a light source

9. An imaging device for motion detection of objects in a scene according to claim 1, wherein any combination of solid state based elements for image capturing, illumination and acoustic image capturing share the same substrate.

10. An imaging device for motion detection of objects in a scene according to claim 1, wherein the obtained images are played in video sequence.

11. An imaging device for motion detection of objects in a scene according to claim 1, wherein 3D position means are obtained.

12. A method of forming an image of a moving object, comprising:
receiving a first image information from an image processor
receiving a second image information from an image processor
clipping the first and second image information
comparing the first and second image information
receiving 3D features coordinates from a depth detection means for detecting the 3D position, generating a 3D map from the 3D features coordinates
generating velocity vectors from position displacement between the first and second image information
processing said 3D feature coordinates and velocity vectors to 3D velocity vectors
processing 3D velocity vectors to application notification protocols, user interface and related display unit.
